(19) United States
(12) Patent Application Publication
(10) Pub. No.: US 2013/0257355 A1
(43) Pub. Date: Oct. 3, 2013

(54) SYSTEM FOR CHARGING AN ENERGY STORE, AND METHOD FOR OPERATING THE CHARGING SYSTEM

(71) Applicants: Peter Feuerstack, Ludwigsburg (DE); Erik Weissenborn, Stuttgart (DE)

(72) Inventors: Peter Feuerstack, Ludwigsburg (DE); Erik Weissenborn, Stuttgart (DE)

(21) Appl. No.: 13/825,260

(22) PCT Filed: Aug. 24, 2011
(86) PCT No.: PCT/EP2011/064563

§ 371 Date: Jun. 6, 2013

(30) Foreign Application Priority Data
Sep. 20, 2010 (DE) 10 2010 041 077.2

(51) Int. Cl. H02J 7/00

(52) U.S. Cl. CPC H02J 7/0013
USPC 320/107

(57) ABSTRACT

A system for charging at least one energy reservoir cell in a controllable energy reservoir which serves to control and supply electrical energy to an n-phase electrical machine where n≧1. The controllable energy reservoir has n parallel energy supply branches that each have at least two energy reservoir modules, connected in series, that each encompass at least one electrical energy reservoir cell having an associated controllable coupling unit. The energy supply branches are connected on the one hand to a reference bus and on the other hand to a respective phase of the electrical machine. As a function of control signals, the coupling units either interrupt the energy supply branch or bypass the respectively associated energy reservoir cells or switch the respectively associated energy reservoir cells into the energy supply branch. All energy supply branches are connectable via at least one inductance and one rectifier unit to an external energy supply network. The reference bus is furthermore connectable to the rectifier unit.

### FIELD

The present invention relates to a system for charging an energy reservoir, and to a method for operating the charging system.

### BACKGROUND INFORMATION

It is becoming apparent that in the future, both for stationary applications such as wind power installations and in vehicles such as hybrid or electric vehicles, increasing use will be made of electronic systems that combine new energy storage technologies with electrical drive technology. In conventional applications an electrical machine, which is embodied, e.g., as a phase-sequence machine, is controlled via a converter in the form of an inverter. A characteristic of such systems is a so-called DC link circuit through which an energy reservoir, usually a battery, is connected to the DC voltage side of the inverter. In order to be able to meet the demands of a particular application in terms of power output and energy, multiple battery cells are connected in series. Because the current furnished by an energy reservoir of this kind must flow through all the battery cells, and because a battery cell can conduct only a limited current, battery cells are often additionally connected in parallel in order to increase the maximum current.

A series circuit of multiple battery cells yields not only a high total voltage but also the problem that the entire energy reservoir fails if a single battery cell fails, since battery current can then no longer flow. Such a failure of the energy reservoir can result in failure of the entire system. In a vehicle, a failure of the drive battery can leave the vehicle “stranded.” In other applications, for example rotor blade adjustment of wind power installations, unfavorable boundary conditions such as, for example, high wind can in fact lead to hazardous situations. A high level of reliability of the energy reservoir is therefore always desirable, “reliability” referring to the ability of a system to operate in fault-free fashion for a predetermined time.

German Patent Application Nos. DE 10 2010 027857 and DE 10 2010 027861 describe batteries having multiple battery module sections that are connectable directly to an electrical machine. The battery module sections have a plurality of battery modules connected in series, each battery module having at least one battery cell and an associated controllable coupling unit that makes it possible, as a function of control signals, to interrupt the respective battery module section or bypass the respectively associated (at least one) battery cell or switch the respectively associated (at least one) battery cell into the respective battery module section. By appropriate application of control to the coupling units, e.g., with the aid of pulse width modulation, it is also possible to furnish suitable phase signals in order to control the electrical machine, so that a separate pulse width modulated inverter can be omitted. The pulse width modulated inverter required in order to control the electrical machine is thus, so to speak, integrated into the battery. For purposes of disclosure, these two earlier Applications are incorporated in their entirety into the present Application.

### SUMMARY

In accordance with the present invention, an example system is provided for charging at least one energy reservoir cell in a controllable energy reservoir which serves to control and supply electrical energy to an n-phase electrical machine where n≧1. The controllable energy reservoir has n parallel energy supply branches that each have at least two energy reservoir modules, connected in series, that each encompass at least one electrical energy reservoir cell having an associated controllable coupling unit. As a function of control signals, the coupling units either interrupt the energy supply branch or bypass the respectively associated energy reservoir cells or switch the respectively associated energy reservoir cells into the energy supply branch. All energy supply branches are connectable via at least one inductance and one rectifier unit to an external energy supply network, in particular to a public AC or three-phase power network. The reference bus is furthermore connectable to the rectifier unit.

In accordance with the present invention, an example method is provided for operating a charging system according to the present invention, in which all energy supply branches are connected via at least one inductance and one rectifier unit to an external energy supply network, in particular to a public power network, and the reference bus is connected to the rectifier unit. In a charging phase, all coupling units of those energy reservoir modules that are located in an energy supply branch of energy reservoir cells to be charged are controlled in such a way that the respectively associated energy reservoir cells are bypassed. In a free-wheeling phase following the charging phase, all coupling units that are associated with energy reservoir cells to be charged are controlled in such a way that the associated energy reservoir cells are switched into the respective energy supply branch. All coupling units that are located in the energy supply branch of energy reservoir cells to be charged, but that are not themselves associated with any energy reservoir cells to be charged, are controlled in such a way that the respectively associated energy reservoir cells are bypassed.

In order to comply with electromagnetic compatibility (EMC) standards, it is often necessary to use power factor correction or power factor compensation (PFC) for charging devices. This regulates the received line power by way of a power switch to a sinusoidal profile, thereby minimizing its harmonic content. Line voltage fluctuations can also be compensated for. A typical implementation of a PFC circuit encompasses a bridge rectifier as well as a downstream step-up converter stage, as depicted in FIG. 1. In accordance with the present invention, the coupling units of the controllable energy reservoir are used, which are in any case present, to realize a charging function with power factor correction. This is implemented by the fact that the coupling units are operated, during a charging operation, in a manner analogous to the switch elements of a step-up converter; in a charging phase, energy is conveyed to the at least one inductance and stored there, and is then conveyed in a free-wheeling phase to the energy reservoir cells to be charged. This involves only minimal additional hardware outlay for the requisite free-wheeling diodes, which is consistent with low cost and little space requirement.

The example systems and methods according to the present invention make possible both the charging of energy reservoir cells of an individual energy reservoir module, and simultaneous charging of energy reservoir cells of multiple energy reservoir modules. In the case of a multi-phase electrical machine, the energy reservoir cells of energy reservoir modules that are located in different energy supply branches can also be charged simultaneously.

The motor inductance, in the form of stator windings of the electrical machine, can advantageously also be co-utilized to implement the charging function with power factor correction. This can be implemented by the fact that the stator windings are used during a charging operation as inductances of a step-up converter. An example embodiment of the present invention thus provides that the energy supply branches are connectable on the one hand to a reference potential—hereinafter referred to as a “reference bus”—and on the other hand to a respective phase of the electrical machine, and the at least one inductance is constituted at least in part by stator windings of the electrical machine.

When the motor inductance of the electrical machine is co-utilized, however, it is important to avoid the buildup of undesired torques in the electrical machine during charging operation. This can be implemented by the fact that the electrical machine is mechanically blocked during the charging operation, for example with the aid of a linkage detent pawl. Alternatively, the rotor position of the electrical machine can also be monitored, for example with the aid of a corresponding sensor suite, and shut off in the event a rotor motion is detected.

If the phases of the electrical machine are interconnected in a star configuration, provision is then made according to an example embodiment of the present invention that the rectifier unit encompasses a rectifier, in particular a diode rectifier, and a star point of the phases of the electrical machine is connectable to the rectifier.

If the inductances of the stator windings of the electrical machine are not sufficient, an additional charging inductance can be inserted between the rectifier and the star point of the electrical machine.

If the phases are, on the other hand, interconnected in an n-point configuration, provision is then made according to an embodiment of the present invention that the rectifier unit encompasses n rectifiers, in particular diode rectifiers, and each phase of the electrical machine is connectable to one respective rectifier.

In this case as well, additional charging inductances can be provided if the inductances of the stator windings of the electrical machine are insufficient, the phases of the electrical machine each being connectable via an additional charging inductance to a respective rectifier.

To further improve EMC, according to a further embodiment of the present invention a power supply filter is insertable between the rectifier unit and the external energy supply network.

Further features and advantages of example embodiments of the present invention are evident from the description below with reference to the figures.

### BRIEF DESCRIPTION OF THE DRAWINGS

FIG. 1 schematically depicts a PFC circuit.

FIG. 2 schematically depicts an example charging system according to the present invention in a charging phase from a single-phase energy supply network.

FIG. 3 shows the system according to FIG. 2 in a free-wheeling phase.

FIG. 4 is a schematic general depiction of an example charging system according to the present invention in the context of charging from a three-phase energy supply network (electrical machine in star configuration).

FIG. 5 is a schematic general depiction of an example charging system according to the present invention in the context of charging from a three-phase energy supply network (electrical machine in delta configuration).

### DETAILED DESCRIPTION OF EXAMPLE EMBODIMENTS

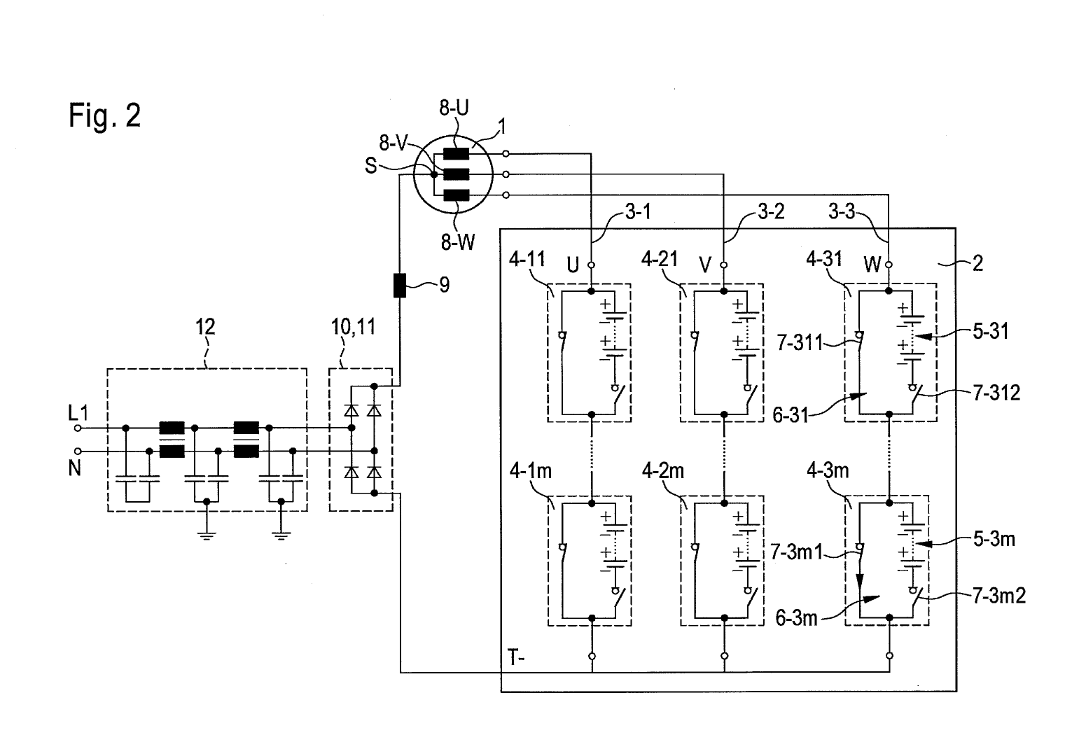

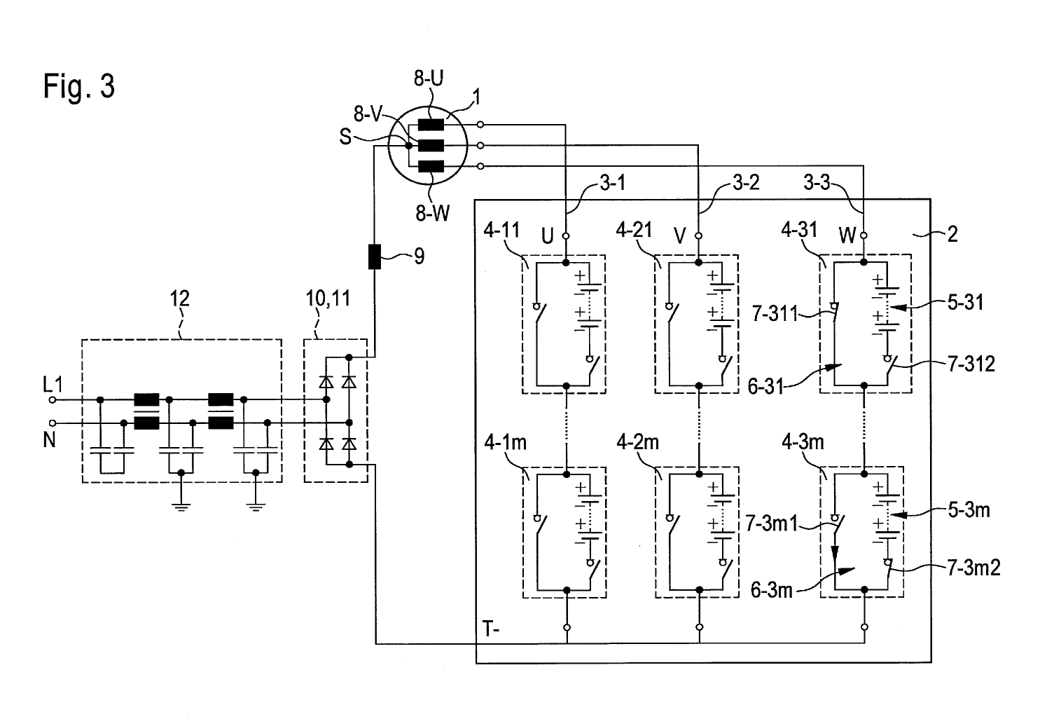

FIGS. 2 and 3 schematically depict an example charging system according to the present invention. A controllable energy reservoir 2 is connected to a three-phase electrical machine 1. Controllable energy reservoir 2 encompasses three energy supply branches 3-1, 3-2, and 3-3, which are connected on the one hand to a reference potential T− (reference bus) that, in the embodiment depicted, carries a low potential, and on the other hand respectively to individual phases U, V, W of electrical machine 1. Each of energy supply branches 3-1, 3-2, and 3-3 has, connected in series, m energy reservoir modules 4-11 to 4-1m, 4-21 to 4-2m, and 4-31 to 4-3m respectively, where m≧2. Energy reservoir modules 4 in turn each encompass multiple electrical energy reservoir cells connected in series which, for reasons of clarity, are labeled only in energy supply branch 3-3 connected to phase W of electrical machine 1, with reference characters 5-31 to 5-3m. Energy reservoir modules 4 furthermore each encompass a coupling unit that is associated with energy reservoir cells 5 of the respective energy reservoir module 4. For reasons of clarity, the coupling units too are labeled only in energy supply branch 3-3, with reference characters 6-31 to 6-3m. In the variant embodiment depicted, coupling units 6 are each constituted by two controllable switch elements 7-311 and 7-312 to 7-3m1 and 7-3m2. The switch elements can be embodied as power semiconductor switches, e.g. in the form of insulated gate bipolar transistors (IGETs) or as metal oxide semiconductor field-effect transistors (MOSFETs).

Coupling units 6 make it possible to interrupt the respective energy supply branch 3 by opening both switch elements 7 of a coupling unit 6. Alternatively, energy reservoir cells 5 either can be bypassed by closing one of the respective switch elements 7 of a coupling unit 6, for example by closing switch 7-311, or can be switched into the respective energy supply branch 3, for example by closing switch 7-312.

The total output voltages of energy supply branches 3-1 to 3-3 are determined by the respective switching state of the controllable switch elements 7 of coupling units 6, and can be adjusted in steps. The steps occur as a function of the voltage of the individual energy reservoir modules 4. Proceeding from the preferred embodiment of identically configured energy reservoir modules 4, what results then as a maximum possible total output voltage is the voltage of an individual energy reservoir module 4 times the number m of energy reservoir modules 4 connected in series in each energy supply branch.

Coupling units 6 thus make it possible to switch phases U, V, W of electrical machine 1 toward either a high reference potential or a low reference potential, and can in that regard also perform the function of a known inverter. The power output and operating mode of electrical machine 1 can thus be controlled, with appropriate application of control to coupling units 6, by controllable energy reservoir 2. Controllable energy reservoir 2 thus performs a dual function in this regard, since it serves not only to supply electrical energy to electrical machine 1 but also to control it.

Electrical machine 1 has stator windings 8-U, 8-V and 8-W that are interconnected with one another in conventional fashion in a star configuration.

In the exemplifying embodiment depicted, electrical machine 1 is embodied as a three-phase rotary current machine, but it can also have fewer or more than three phases. The number of phases of the electrical machine of course also governs the number of energy supply branches 3 in controllable energy reservoir 2.

In the exemplifying embodiment depicted, each energy reservoir module 4 has multiple respective energy reservoir cells 5 connected in series. Energy reservoir modules 4 can, however, alternatively also have only a single energy reservoir cell or also energy reservoir cells connected in parallel.

In the exemplifying embodiment depicted, coupling units 6 are each constituted by two controllable switch elements 7. Coupling units 6 can, however, also be realized using more or fewer controllable switch elements, provided the necessary functions (interruption of the energy supply branch, bypassing of the energy reservoir cells, and switching of the energy supply cells into the energy supply branch) can be realized. Examples of alternative embodiments of a coupling unit are evident from the earlier Applications DE 10 2010 027857 and DE 10 2010 027861. It is moreover also possible, however, for the coupling elements to have switch elements in a full bridge configuration, which offers the additional capability of a voltage reversal at the output of the energy reservoir module.

In order to enable the charging of energy reservoir cells 5 of one or more energy reservoir modules 4, a star point S of electrical machine 1 is connected via an additional charging inductance 9 to a rectifier unit 10. Reference bus T− is also connected to rectifier unit 10. Be it noted that additional charging inductance 9 is not necessary for the usability of the present invention, and can be used only when the inductances of stator windings 8-U, 8-V, and 8-W are not sufficient to realize the charging function or the necessary power factor correction. In the exemplifying embodiment depicted, rectifier unit 10 encompasses by way of example a diode rectifier 11 in B2 configuration. Diode rectifier 11 is connectable via a power supply filter 12 (known per se) to a single-phase external energy supply network (not depicted), in particular a public (AC) power network.

The charging operation of energy reservoir cells 5 of an individual energy reservoir module 4, namely energy reservoir cells 5-3m of energy reservoir module 4-3m in energy supply branch 3-3, is described below by way of example.

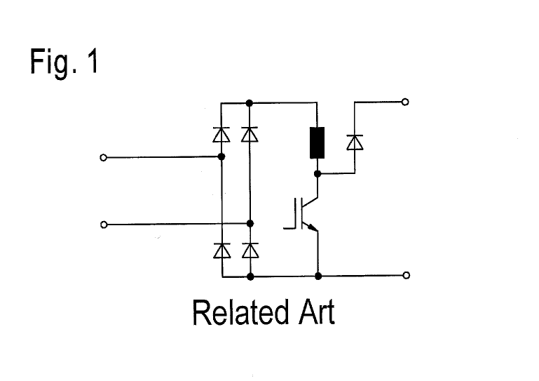

During a charging phase depicted in FIG. 1, coupling units 6-31 to 6-3m of energy reservoir modules 4-31 to 4-3m, which are located in energy supply branch 3-3 in which energy reservoir cells 5-3m to be charged are also located, are controlled by a control unit (not depicted) in such a way that the respectively associated energy reservoir cells 5-31 to 5-3m are bypassed. This is achieved concretely by the fact that switch elements 7-311 to 7-3m1 are closed, whereas switch elements 7-312 to 7-3m2 are opened. All remaining coupling units 6, i.e., all coupling units 6 in energy reservoir modules 4 of the other two energy supply branches 3-1 and 3-2, are likewise controlled in such a way that the respectively associated energy reservoir cells 5-31 to 5-3m are bypassed. This type of control of coupling units 6, in energy supply branches 3-1 and 3-2 that do not encompass any energy reservoir cells 5 to be charged, is useful in order to achieve, in principle, a charging option for these energy reservoir cells as well. Be it noted, however, that coupling units 6 in energy supply branches 3-1 and 3-2 that contain no energy reservoir cells 5 to be charged can also have control applied to them differently, in particular in such a way that the respective energy supply branches 3-1 and/or 3-2 are interrupted.

The bypassing of energy reservoir cells 5-31 to 5-3m, in energy supply branch 3-3 in which energy reservoir cells 5-3m are also located, produces a current flow through additional charging inductance 9 and through stator winding 8-W, so that electrical energy is stored in additional charging inductance 9 and in stator winding 8-W during the charging phase.

In a free-wheeling phase that follows the charging phase and is depicted in FIG. 3, coupling unit 6-3m that is associated with energy reservoir cells 5-3m to be charged is controlled in such a way that the associated energy reservoir cells 5-31 are switched into energy supply branch 3-3. This is achieved concretely by the fact that switch element 7-3m2 is closed and switch element 7-3m1 is opened. All remaining coupling units 6-32 to 6-3m, which are located in energy supply branch 3-3 of energy reservoir cells 5-31 to be charged, but are not themselves associated with any energy reservoir cells 5 to be charged, are controlled in such a way that the respectively associated energy reservoir cells are bypassed (switch elements 7-311 to 7-3(m-1)1 closed, and switch elements 7-312 to 7-3(m-1)2 opened). All remaining coupling units 6, i.e. all coupling units 6 in energy reservoir modules 4 of the other two energy supply branches 3-1 and 3-2, are controlled in such a way that the respective energy supply branches 3-1 and 3-2 are interrupted. This is achieved concretely by the fact that both switch elements 7 of coupling units 6 are opened in each case.

Controlling coupling units 6-31 to 6-3m in this manner produces an electrical connection of additional charging inductance 9 and stator winding 8-W to energy reservoir cells 5-3m that are to be charged. Additional charging inductance 9 and the inductance of stator winding 8-W drive the current, and thereby charge energy reservoir cells 5-3m.

In the example embodiment depicted in FIGS. 2 and 3, the inductances of stator windings 8-U, 8-V, and 8-W are co-utilized as inductances of a power factor correction function. Coupling units 6 implement control, necessary for the realization of power factor correction, of the received line power, in which context coupling units 6 are controlled by way of a suitable duty cycle. Because the power factor correction function is conventional, it will not be further explained here.

To avoid the generation of undesired torques in electrical machine 1 during charging operation, electrical machine 1 can be mechanical blocked during the charging operation, e.g. with the aid of a linkage detent pawl. Alternatively, the rotor position of electrical machine 1 can also be monitored, for example with the aid of a corresponding sensor suite, and shut off in the event a rotor motion is detected.

Alternatively to the example embodiment depicted, the inductance necessary for power factor correction can also be constituted exclusively by an external charging inductance, for example additional charging inductance 9, without using stator windings 8-U, 8-V, and 8-W.

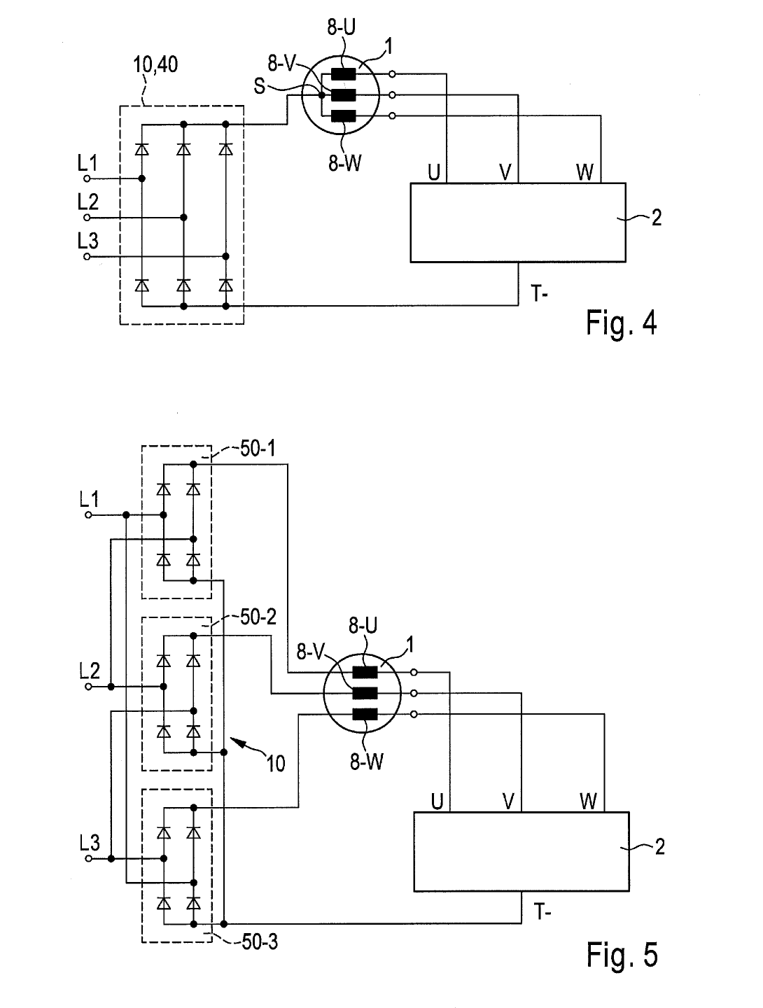

FIGS. 4 and 5 schematically depict, by way of example, the principle of a charging system according to an example embodiment of the present invention when charging from a three-phase energy supply network. Stator windings 8-U, 8-V, and 8-W of the electrical machine according to FIG. 4 are connected in a star configuration, analogously to what is depicted in FIGS. 2 and 3. The charging system according to FIG. 4 thus differs from the charging system depicted in FIGS. 2 and 3 only in that rectifier unit 10 encompasses, instead of a diode rectifier in B2 configuration, a diode rectifier 40 in B6 configuration that is connectable, directly or via a power supply filter (not depicted) to a three-phase external energy supply network (not depicted), in particular a public (three-phase) power network.

In the charging system according to FIG. 5, stator windings 8-U, 8-V, and 8-W are interconnected not in a star configuration but in a delta configuration. With this type of configuration of electrical machine 1, rectifier unit 10 for each phase U, V, W of electrical machine 1 encompasses a separate rectifier 50-1, 50-2, 50-3 respectively, which are embodied by way of example as diode rectifiers in B2 configuration. Each phase U, V, W, and each stator winding 8-U, 8-V, and 8-W of electrical machine 1, is connected to a respective rectifier 50-1, 50-2, 50-3. Rectifiers 50-1, 50-2, and 50-3 are in turn connectable, directly or via a power supply filter (not depicted) to a three-phase external energy supply network (not depicted), in particular a public (three-phase) power network. The individual rectifiers 50-1, 50-2, and 50-3 are respectively connectable to two phases L1 and L2, L2 and L3, and L1 and L3 of the external energy supply network.

For the example embodiments of the present invention depicted in FIGS. 4 and 5 as well, it is the case that the inductances necessary for implementing power factor correction can be constituted, as depicted, by the motor inductances of electrical machine 1 or, alternatively thereto, by external charging inductances, or by a combination of motor inductances with external charging inductances.

To ensure that the energy stored during the charging phase in the inductance(s) can be dissipated in the free-wheeling phase, and that a sufficient power factor is attainable, the minimum total voltage at an energy supply branch 3-1, 3-2, 3-3 (discharged state) must be greater than a peak value of the rectified line voltage.

1-8. (canceled)

9. A system for charging at least one energy reservoir cell in a controllable energy reservoir which serves to control and supply electrical energy to an n-phase electrical machine where n≧1, the system comprising:
n parallel energy supply branches that each have at least two energy reservoir modules connected in series that each encompass at least one electrical energy reservoir cell having an associated controllable coupling unit;
wherein the coupling units, are configured to, as a function of control signals, interrupt the respective energy supply branch or bypass the respectively associated energy reservoir cells or switch the respectively associated energy reservoir cells into the energy supply branch;
wherein all energy supply branches are connectable via at least one inductance and one rectifier unit to an external energy supply network; and
wherein a reference bus is connectable to the rectifier unit.

10. The system as recited in claim 9, wherein the external energy supply network is a public power network.

11. The system as recited in claim 9, wherein the energy supply branches are connectable on the one hand to the reference bus and on the other hand to a respective phase of the electrical machine, and the at least one inductance includes stator windings of the electrical machine.

12. The system as recited in claim 11, wherein the rectifier unit includes a diode rectifier, the phases of the electrical machine are interconnected in a star configuration, and a star point of the phases of the electrical machine is connectable to the rectifier.

13. The system as recited in claim 12, wherein an additional charging inductance is between the rectifier and the star point of the electrical machine.

14. The system as recited in claim 11, wherein the rectifier unit includes n diode rectifiers, the phases of the electrical machine are interconnected in an n-point configuration, and each phase of the electrical machine is connectable to a respective rectifier.

15. The system as recited in claim 14, wherein the phases of the electrical machine are each connectable via an additional charging inductance to the respective rectifier.

16. The system as recited in claim 9, wherein a power supply filter is between the rectifier unit and the external energy supply network.

17. A method for operating a charging system, the charging system including n parallel energy supply branches that each have at least two energy reservoir modules connected in series that each encompass at least one electrical energy reservoir cell having an associated controllable coupling unit, wherein the coupling units, are configured to, as a function of control signals, interrupt the energy supply branch or bypass the respectively associated energy reservoir cells or switch the respectively associated energy reservoir cells into the energy supply branch, wherein all energy supply branches are connectable via at least one inductance and one rectifier unit to an external energy supply network, and wherein a reference bus is connectable to the rectifier unit, the method comprising:
connecting all energy supply branches via at least one inductance and one rectifier unit to the external energy supply network, and connecting the reference bus to the rectifier unit;
in a charging phase:
controlling all coupling units of those energy reservoir modules that are located in an energy supply branch of energy reservoir cells to be charged in such a way that the respectively associated energy reservoir cells are bypassed; and
in a free-wheeling phase following the charging phase:
controlling all coupling units that are associated with energy reservoir cells to be charged in such a way that the associated energy reservoir cells are switched into the respective energy supply branch;
controlling all coupling units that are located in the energy supply branch of energy reservoir cells to be charged, but that are not themselves associated with any energy reservoir cells to be charged, in such a way that the respectively associated energy reservoir cells are bypassed; and
controlling all remaining coupling units in such a way that the respective energy supply branches are interrupted.
